(19) United States
(12) Patent Application Publication
(10) Pub. No.: US 2026/0097512 A1
(43) Pub. Date: Apr. 9, 2026

(54) METHOD FOR CALIBRATING A MOBILE ROBOT

(71) Applicants: TE Connectivity Solutions GmbH, Schaffhausen (CH); Tyco Electronics (Shanghai) Co., Ltd., Shanghai (CN)

(72) Inventors: Liao (Leo) Chen, Shanghai (CN); Xianghao (Jorge) Bao, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/352,676

(22) Filed: Oct. 8, 2025

(30) Foreign Application Priority Data
Oct. 9, 2024 (CN) 202411411275.4

(51) Int. Cl. B25J 9/16; B25J 5/00; B25J 19/02

(52) U.S. Cl. CPC B25J 9/1692; B25J 5/007; B25J 9/1697; B25J 19/023

(57) ABSTRACT

A method for calibrating a mobile robot includes installing a 2D camera at an end of a mechanical arm, moving the 2D camera to a plurality of different poses by the mechanical arm, and capturing images of a calibration plate on a workbench at the plurality of different poses. The method includes calculating a transfer matrix of the 2D camera relative to the calibration plate at each pose of the plurality of different poses based on the images. A transfer matrix ^{end}T_{camer} of the end of the mechanical arm relative to the 2D camera is calculated based on the transfer matrix of the 2D camera relative to the calibration plate, and a transfer matrix ^{base}T_{object} of a base of the mechanical arm relative to the calibration plate is calculated based on the calculated transfer matrix ^{end}T_{camer} and the transfer matrix of the 2D camera relative to the calibration plate.

### CROSS-REFERENCE TO RELATED APPLICATIONS

This application claims the benefit of the filing date under 35 U.S.C. § 119(a)-(d) of Chinese Patent Application No. 202411411275.4, filed on Oct. 9, 2024.

### FIELD OF THE INVENTION

The present invention relates to a method for calibrating a mobile robot.

### BACKGROUND OF THE INVENTION

Before a mobile robot performs an operation on a workbench, a transfer matrix of a base of a mechanical arm of the mobile robot relative to the workbench must be calibrated to improve the operation accuracy of the mobile robot, so that a deviation of a movement trajectory of the mobile robot can be prevented. Since the mechanical arm performs three-dimensional movements, including translational movements along three axes X, Y, and Z perpendicular to each other, and rotational movements around the axes X, Y, and Z, methods for calibrating the mobile robot are typically complex, time-consuming and costly, e.g., requiring the use of a plurality of 3D cameras.

### SUMMARY OF THE INVENTION

A method for calibrating a mobile robot includes installing a 2D camera at an end of a mechanical arm, moving the 2D camera to a plurality of different poses by the mechanical arm, and capturing images of a calibration plate on a workbench at the plurality of different poses. The method includes calculating a transfer matrix of the 2D camera relative to the calibration plate at each pose of the plurality of different poses based on the images. A transfer matrix ^{end}T_{camer} of the end of the mechanical arm relative to the 2D camera is calculated based on the transfer matrix of the 2D camera relative to the calibration plate, and a transfer matrix ^{base}T_{object} of a base of the mechanical arm relative to the calibration plate is calculated based on the calculated transfer matrix ^{end}T_{camer} and the transfer matrix of the 2D camera relative to the calibration plate.

### BRIEF DESCRIPTION OF DRAWINGS

In the following, the present invention is described in more detail with reference to the drawings, in which:

FIG. 1 shows an illustrative view of a mobile robot and a workbench according to an exemplary embodiment of the present invention; and

FIG. 2 shows an illustrative view of moving a 2D camera to a plurality of different poses and capturing images of a calibration plate at the plurality of poses.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

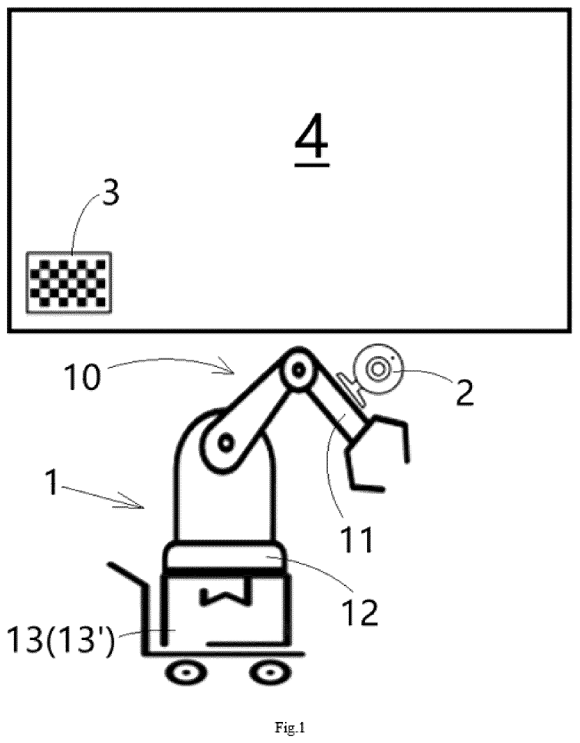

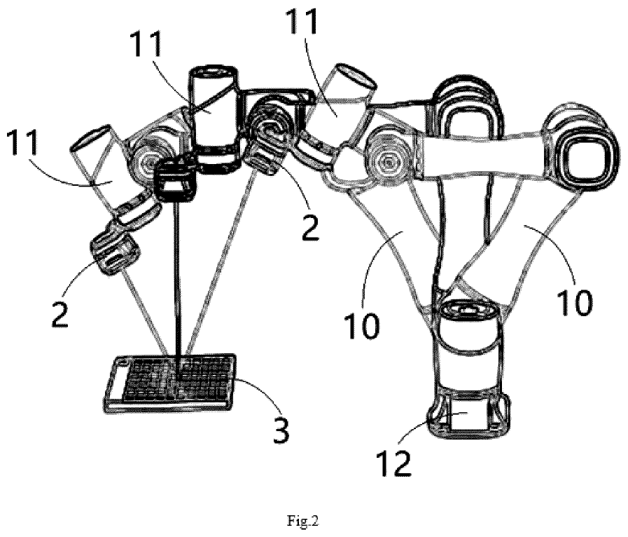

As shown in FIGS. 1 and 2, in an exemplary embodiment of the present invention, a method for calibrating a mobile robot is disclosed. The method for calibrating a mobile robot includes the following steps:
S10: installing a 2D camera 2 at an end 11 of a mechanical arm 10 of a mobile robot 1;
S20: moving the 2D camera 2 to a plurality of different poses by the mechanical arm 10, and capturing images of a calibration plate 3 on a workbench 4 at the plurality of different poses;
S30: calculating a transfer matrix of the 2D camera 2 relative to the calibration plate 3 at each pose based on the images of the calibration plate 3 captured by the 2D camera 2 at the plurality of different poses;
S40: calculating a transfer matrix ^{end}T_{camer} of the end 11 of the mechanical arm 10 relative to the 2D camera 2 based on the transfer matrix of the 2D camera 2 relative to the calibration plate 3 at each pose; and
S50: calculating a transfer matrix ^{base}T_{object} of a base of the mechanical arm 10 relative to the calibration plate 3 based on the calculated transfer matrix ^{end}T_{camer} and the transfer matrix of the 2D camera 2 relative to the calibration plate 3 at each pose.

As shown in FIGS. 1 and 2, in the illustrated embodiment, the transfer matrix ^{base}T_{object} is a transfer matrix of a base of the mechanical arm 10 relative to the calibration plate, since the calibration plate 3 is on the workbench.

As shown in FIGS. 1 and 2, in the illustrated embodiment, in S10, an installation position of the 2D camera 2 at the end 11 of the mechanical arm 10 is arbitrarily selected, improving convenience.

As shown in FIGS. 1 and 2, in the illustrated embodiment, in S30, calculating the transfer matrix of the 2D camera 2 relative to the calibration plate 3 based on the images of the calibration plate 3 captured by the 2D camera 2 includes the following steps:
S301: processing the captured images of the calibration plate 3 and extracting and identifying feature points on the calibration plate 3;
S302: calculating an internal parameter and an external parameter of the 2D camera 2 based on positional information of the extracted feature points; and
S303: calculating a transfer matrix of the 2D camera 2 relative to the calibration plate 3 based on the calculated internal parameter and external parameter of the 2D camera 2.

As shown in FIGS. 1 and 2, in the illustrated embodiment, a two-dimensional code or a checkerboard pattern is formed on the calibration plate 3, and the feature points are corner points and intersection points on the two-dimensional code or the checkerboard pattern.

As shown in FIGS. 1 and 2, in the illustrated embodiment, the plurality of different poses include a first pose and a second pose different from the first pose. In S40, the transfer matrix ^{end}T_{camer} of the end 11 of the mechanical arm 10 relative to the 2D camera 2 is solved based on the following matrix equation, ^{base}T_{end1}×^{end}T_{camer}×^{camer1}T_{object1}=^{base}T_{end2}×^{end}T_{camer}×^{camer2}T_{object2},
wherein ^{base}T_{end1} and ^{base}T_{end2} are known, and represent transfer matrices of the base of the mechanical arm 10 relative to the end 11 of the mechanical arm 10 at the first pose and the second pose, respectively; ^{camer1}T_{object1} represents a transfer matrix of the 2D camera 2 relative to the calibration plate 3 at the first pose and is calculated based on an image of the calibration plate 3 captured by the 2D camera 2 at the first pose; and ^{camer2}T_{object2} represents a transfer matrix of the 2D camera 2 relative to the calibration plate 3 at the second pose, and is calculated based on an image of the calibration plate 3 captured by the 2D camera 2 at the second pose.

As shown in FIGS. 1 and 2, in the illustrated embodiment, in S50, the transfer matrix ^{base}T_{object} of the base of the mechanical arm 10 relative to the calibration plate 3 is calculated based on the following formula: ^{base}T_{object}=^{base}T_{end1}×^{end}T_{camer} ^{camer1}T_{object1}; or ^{base}T_{object}=^{base}T_{end2}×^{end}T_{camer}×^{camer2}T_{object2}.

As shown in FIGS. 1 and 2, in the illustrated embodiment, the aforementioned S20 includes: S21: moving the 2D camera 2 to the first pose by the mechanical arm 10 and capturing a first image of the calibration plate 3 on the workbench 4 at the first pose; and S22: moving the 2D camera 2 to the second pose different from the first pose by the mechanical arm 10 and capturing a second image of the calibration plate 3 on the workbench 4 at the second pose.

As shown in FIGS. 1 and 2, in the illustrated embodiment, the aforementioned S30 includes: S31: calculating the transfer matrix ^{camer1}T_{object1} of the 2D camera 2 relative to the calibration plate 3 at the first pose based on the first image of the calibration plate 3 captured by the 2D camera 2; and S32: calculating the transfer matrix ^{camer2}T_{object2} of the 2D camera 2 relative to the calibration plate 3 at the second pose based on the second image of the calibration plate 3 captured by the 2D camera 2.

As shown in FIGS. 1 and 2, in the illustrated embodiment, the mobile robot 1 is stopped and fixed at a predetermined position beside the workbench 4 throughout execution of an operation by the mobile robot on the workbench 4. After S50, the 2D camera 2 is removed from the hand-operated mobile robot 1 to relieve a load on the end 11 of the mechanical arm 10.

As shown in FIGS. 1 and 2, in the illustrated embodiment, the calibration steps S10 to S50 are re-executed after the mobile robot 1 is moved from the original workbench 4 to a new workbench 4, and the 2D camera 2 is removed from the mobile robot 1 again after the calibration steps S10 to S50 are re-executed.

As shown in FIGS. 1 and 2, in the illustrated embodiment, the mobile robot 1 includes a hand-operated moving seat 13, and the mechanical arm 10 is installed on the hand-operated moving seat 13 to enable the mobile robot 1 to be moved to the different workbenches 4 by the hand-operated moving seat 13. Prior to S20, the hand-operated moving seat 13 is locked at the predetermined position beside the workbench 4 to ensure that the pose of the base of the mechanical arm 10 relative to the workbench 4 remains unchanged.

As shown in FIGS. 1 and 2, in the illustrated embodiment, the mobile robot 1 moves between different positions beside the workbench 4 during execution of an operation by the mobile robot 1 on the workbench 4. The calibration steps S10 to S50 are executed when the mobile robot 1 is stopped at an initial position beside the workbench 4. When the mobile robot 1 is moved from the initial position to a new position beside the workbench 4, the following calibration steps are executed:
S60: capturing an image of the calibration plate 3 using the 2D camera 2 and calculating a transfer matrix of the 2D camera 2 relative to the calibration plate 3 based on the captured image; and
S70: re-calculating a transfer matrix ^{base}T_{object} of the base of the mechanical arm 10 relative to the calibration plate 3 based on the transfer matrix ^{end}T_{camer} calculated at the initial position and the transfer matrix of the 2D camera 2 relative to the calibration plate 3 calculated at the new position.

As shown in FIGS. 1 and 2, in the illustrated embodiment, the 2D camera 2 is no longer removed after being installed at the end 11 of the mechanical arm 10, and after the mobile robot 1 is moved from the original workbench 4 to the new workbench 4, the following calibration steps are executed:
S80: capturing an image of the calibration plate 3 on the new workbench 4 using the 2D camera 2, and calculating a transfer matrix of the 2D camera 2 relative to the calibration plate (3) on the new workbench 4 based on the captured image; and
S90: calculating a transfer matrix ^{base}T_{object} of the base of the mechanical arm 10 relative to the calibration plate 3 on the new workbench 4 based on the transfer matrix of the 2D camera 2 relative to the calibration plate 3 on the new workbench 4 and the transfer matrix ^{end}T_{camer} calculated on the original workbench 4.

As shown in FIGS. 1 and 2, in the illustrated embodiment, the mobile robot 1 includes an automatic moving vehicle 13′, and the mechanical arm 10 is installed on the automatic moving vehicle 13′ to enable the mobile robot 1 to move between different positions beside the same workbench 4 and between the different workbenches 4.

The present invention enables automatic calibration of a mobile robot, eliminating deviations in its movement trajectory and improving the operation accuracy of the mobile robot. In this invention, only a standard 2D camera is required, which reduces the calibration cost. The installation position of the 2D camera is not subject to any special requirements and can be arbitrarily selected.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A method for calibrating a mobile robot, comprising:
installing a 2D camera at an end of a mechanical arm of a mobile robot;
moving the 2D camera to a plurality of different poses by the mechanical arm, and capturing images of a calibration plate on a workbench at the plurality of different poses;
calculating a transfer matrix of the 2D camera relative to the calibration plate at each pose of the plurality of different poses based on the images of the calibration plate captured by the 2D camera at the plurality of different poses;
calculating a transfer matrix ^{end}T_{camer} of the end of the mechanical arm relative to the 2D camera based on the transfer matrix of the 2D camera relative to the calibration plate at each pose of the plurality of different poses; and
calculating a transfer matrix ^{base}T_{object} of a base of the mechanical arm relative to the calibration plate based on the calculated transfer matrix ^{end}T_{camer} and the transfer matrix of the 2D camera relative to the calibration plate at each pose of the plurality of different poses.

2. The method for calibrating a mobile robot according to claim 1, wherein, in the installing step, an installation position of the 2D camera at the end of the mechanical arm is arbitrarily selected.

3. The method for calibrating a mobile robot according to claim 1, wherein calculating the transfer matrix of the 2D camera relative to the calibration plate based on the images of the calibration plate captured by the 2D camera includes:
processing the captured images of the calibration plate and extracting and identifying a plurality of feature points on the calibration plate;
calculating an internal parameter and an external parameter of the 2D camera based on positional information of the feature points; and
calculating a transfer matrix of the 2D camera relative to the calibration plate based on the internal parameter and the external parameter of the 2D camera.

4. The method for calibrating a mobile robot according to claim 3, wherein a two-dimensional code or a checkerboard pattern is formed on the calibration plate, the feature points are corner points and intersection points on the two-dimensional code or the checkerboard pattern.

5. The method for calibrating a mobile robot according to claim 1, wherein the plurality of different poses include a first pose and a second pose different from the first pose, the transfer matrix ^{end}T_{camer} of the end of the mechanical arm relative to the 2D camera is solved based on the following matrix equation,
$${}^{base} {T}_{end 1} \times {}^{end} {T}_{camer} \times {}^{camer 1} {T}_{object 1} = {}^{base} {T}_{end 2} \times {}^{end} {T}_{camer} \times {}^{camer 2} {T}_{object 2} ,$$
wherein
^{base}T_{end1} and ^{base}T_{end2} are known, and represent transfer matrices of the base of the mechanical arm relative to the end of the mechanical arm at the first pose and the second pose, respectively;
^{camer1}T_{object1} represents a transfer matrix of the 2D camera relative to the calibration plate at the first pose and is calculated based on an image of the calibration plate captured by the 2D camera at the first pose; and
^{camer2}T_{object2} represents a transfer matrix of the 2D camera relative to the calibration plate at the second pose, and is calculated based on an image of the calibration plate captured by the 2D camera at the second pose.

6. The method for calibrating a mobile robot according to claim 5, wherein the transfer matrix ^{base}T_{object} of the base of the mechanical arm relative to the calibration plate is calculated based on the following formula:
$${}^{base} {T}_{object} = {}^{base} {T}_{end 1} \times {}^{end} {T}_{camer} \times {}^{camer 1} {T}_{object 1} ; or$$
$${}^{base} {T}_{object} = {}^{base} {T}_{end 2} \times {}^{end} {T}_{camer} \times {}^{camer 2} {T}_{object 2} .$$

7. The method for calibrating a mobile robot according to claim 5, wherein the moving step includes moving the 2D camera to the first pose by the mechanical arm and capturing a first image of the calibration plate on the workbench at the first pose.

8. The method for calibrating a mobile robot according to claim 7, wherein the moving step includes moving the 2D camera to the second pose different from the first pose by the mechanical arm and capturing a second image of the calibration plate on the workbench at the second pose.

9. The method for calibrating a mobile robot according to claim 8, wherein calculating the transfer matrix of the 2D camera relative to the calibration plate at each pose of the plurality of different poses based on the images of the calibration plate captured by the 2D camera includes calculating the transfer matrix ^{camer1}T_{object1} of the 2D camera relative to the calibration plate at the first pose based on the first image of the calibration plate captured by the 2D camera.

10. The method for calibrating a mobile robot according to claim 9, wherein calculating the transfer matrix of the 2D camera relative to the calibration plate at each post of the plurality of different poses based on the images of the calibration plate captured by the 2D camera includes calculating the transfer matrix ^{camer2}T_{object2} of the 2D camera relative to the calibration plate at the second pose based on the second image of the calibration plate captured by the 2D camera.

11. The method for calibrating a mobile robot according to claim 1, wherein the mobile robot is stopped and fixed at a predetermined position beside the workbench throughout execution of an operation by the mobile robot on the workbench.

12. The method for calibrating a mobile robot according to claim 11, wherein, after calculating the transfer matrix ^{base}T_{object}, the 2D camera is removed from the mobile robot to relieve a load on the end of the mechanical arm.

13. The method for calibrating a mobile robot according to claim 12, wherein the installing, moving, and calculating steps are re-executed after the mobile robot is moved from an original workbench to a new workbench, and the 2D camera is removed from the mobile robot again after the installing, moving, and calculating steps are re-executed.

14. The method for calibrating a mobile robot according to claim 13, wherein the mobile robot has a hand-operated moving seat, and the mechanical arm is installed on the hand-operated moving seat to enable the mobile robot to be moved to the original workbench and the new workbench by the hand-operated moving seat.

15. The method for calibrating a mobile robot according to claim 14, wherein, prior to the moving step, the hand-operated moving seat is locked at the predetermined position beside the workbench to ensure that a position of the base of the mechanical arm relative to the workbench remains unchanged.

16. The method for calibrating a mobile robot according to claim 1, wherein the mobile robot moves between a plurality of different positions beside the workbench during execution of an operation by the mobile robot on the workbench.

17. The method for calibrating a mobile robot according to claim 16, wherein the installing, moving, and calculating steps are executed when the mobile robot is stopped at an initial position beside the workbench, and when the mobile robot is moved from the initial position to a new position beside the workbench, the following calibration steps are executed:
capturing an image of the calibration plate using the 2D camera and calculating a transfer matrix of the 2D camera relative to the calibration plate based on the captured image; and
re-calculating a transfer matrix ^{base}T_{object} of the base of the mechanical arm relative to the calibration plate based on the transfer matrix ^{end}T_{camer} calculated at the initial position and the transfer matrix of the 2D camera relative to the calibration plate calculated at the new position.

18. The method for calibrating a mobile robot according to claim 17, wherein the 2D camera is no longer removed after being installed at the end of the mechanical arm, and after the mobile robot is moved from an original workbench to a new workbench, the following calibration steps are executed:
capturing an image of the calibration plate on the new workbench using the 2D camera, and calculating a transfer matrix of the 2D camera relative to the calibration plate on the new workbench based on the captured image; and
calculating a transfer matrix ^{base}T_{object} of the base of the mechanical arm relative to the calibration plate on the new workbench based on the transfer matrix of the 2D camera relative to the calibration plate on the new workbench and the transfer matrix ^{end}T_{camer} calculated on the original workbench.

19. The method for calibrating a mobile robot according to claim 17, wherein the mobile robot is an automatic moving vehicle, and the mechanical arm is installed on the automatic moving vehicle to enable the mobile robot to move between the different positions beside the same workbench and between the new workbench and the original workbench.
